(19) United States
(12) Patent Application Publication
(10) Pub. No.: US 2022/0286611 A1
(43) Pub. Date: Sep. 8, 2022

(54) ELECTRICAL IMAGE STABILIZATION (EIS)-ASSISTED DIGITAL IMAGE STABILIZATION (DIS)

(71) Applicant: QUALCOMM Incorporated, San Diego, CA (US)

(72) Inventors: Eliad Tsairi, Hof HaCarmel (IL); Ron Gaizman, Hof HaCarmel (IL); Maksym Aslianskyi, Tel Aviv (IL); Aviel Simchi, Haifa (IL); Raveh Ben Simon, Hod Hasharon (IL)

(21) Appl. No.: 17/194,102

(22) Filed: Mar. 5, 2021

(51) Int. Cl. H04N 5/232

(52) U.S. Cl. CPC H04N 5/23258; H04N 5/23254; H04N 5/23267; H04N 5/23212

(57) ABSTRACT

Digital image stabilization (DIS) may be implemented in image capture devices to address some or all above problems of local stabilization and in-frame distortions alone or in combination with electronic image stabilization (EIS) to reduce artifacts, shake leftovers, and other problems resulting from insufficient global stabilization. DIS may use image sensor motion data derived from image-based information, such as motion vectors between frames, to modify captured image data to generate corrected image frames having improved global stabilization and reduced distortion artifacts and shake leftovers resulting from camera motion. The image sensor motion data may be used in combination with non-image sensor motion data, such as data from a gyroscope an optical image stabilization (OIS) device, a magnetometer, an accelerometer, and/or auto-focus (AF) feedback to perform image stabilization. Image sensor motion data may be used to determine a translation (e.g., a three-dimensional displacement) motion of the image capture device.

### FIELD OF THE DISCLOSURE

Aspects of the present disclosure relate generally to image processing. Some features of the disclosure may enable and provide improvements in the processing for image stabilization to improve global and local stabilization caused by translation motion during capture of the image.

### BACKGROUND

Image capture devices, devices that can capture one or more digital images whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

These example image capture devices are often used for capturing images while being held by the user. Motion of the image capture device during the image capture can result in shaky video and distorted frames and blurring or other image quality degradation. One conventional technique for addressing this motion is electronic image stabilization (EIS). EIS tries to detect any motion of the camera and adjust the captured image data to counter the detected motion of the camera, thereby producing a smooth trajectory video and without any distortions. Electronic image stabilization (EIS) may improve global stability of a video that was taken using a shaky movement or shaky trajectory by smoothing the trajectory by handling motion between frames.

### BRIEF SUMMARY OF SOME EXAMPLES

Digital image stabilization (DIS) may be implemented in image capture devices to address some or all above problems of local stabilization and in-frame distortions alone or in combination with electronic image stabilization (EIS) to reduce artifacts, shake leftovers, and other problems resulting from insufficient global stabilization and/or due to data error and modeling errors. DIS may use image sensor motion data derived from image-based information, such as motion vectors between frames, to modify captured image data to generate corrected image frames having improved global stabilization, reduced distortion artifacts, and/or reduced shake leftovers due to camera motion and/or data error and modeling errors. The image sensor motion data may be used in combination with non-image sensor motion data, such as data from a gyroscope an optical image stabilization (OIS) device, a magnetometer, an accelerometer, and/or auto-focus (AF) feedback to perform image stabilization. In some embodiments, image sensor motion data may be used to determine a translation (e.g., a three-dimensional displacement) motion of the image capture device. Image stabilization may be performed with this image sensor motion data to improve stabilization in captured video.

Image sensor motion data may include motion vectors determined from two or more image frames captured by the image capture device. The image sensor motion data, such as the motion vectors, may be determined in an undistorted domain, such as a domain with distortion removed by rolling shutter correction (RSC), lens distortion correction (LDC), optical image stabilization (OIS), and/or focus field-of-view (FOV) correction. The image sensor motion data, such as the motion vectors, may be compensated based on non-image sensor data, such as gyroscope data. The resulting compensated image sensor motion data may represent only translation and/or measurement errors, which reduces the complexity of further processing of an input image frame using the compensated image sensor motion data. For example, the compensated image sensor motion data may be used as part of a digital image stabilization (DIS) correction applied to image data captured by the image capture device. The DIS correction may be applied in addition to EIS correction and other distortion corrections, including RSC, OIS, iFOVC, and/or LDC, to provide an efficient hybrid solution. The generation of compensated image sensor motion data based on the non-image sensor data also reduces processing for DIS by representing only the translation and/or measurement errors, which reduces the complexity of models generated based on the compensated image sensor motion data.

Other data may be useful in correcting an image, in combination with the correction based on image sensor motion data or separate from the correction based on image sensor motion data. During capture of an image frame, the field of view (FOV) of the image sensor may change. For example, when an autofocus (AF) system is changing the lens position to reach a target focal distance, the image frame captured may have different lines of the image captured at different field of views resulting in the image frame having a non-even zoom. As another example, when an autofocus (AF) system is changing the lens position to track an object in the scene that is moving closer or farther from the image sensor, the image frame captured may have different lines of the image captured at different field of views resulting in the image frame having a non-even zoom. The intra-frame focus distance determined based on the lens position may be used to correct the non-even zoom in the image frame and remove or reduce field-of-view distortion as part of an intra-frame field of view (iFOVC) correction.

Particular implementations of the subject matter described in this disclosure may be implemented to realize one or more of the following potential advantages or benefits. In some aspects, the present disclosure provides techniques for improving global stabilization and reducing distortion artifacts and shake leftovers in videos captured by an image capture device. The improvement may be to improving global stabilization and reducing distortion artifacts and shake leftovers caused by a user moving while taking a photograph, such as running alongside an object, and/or blur caused by a user who is unsteady while taking a photograph, such as caused by a shaky hand. The improving of global stabilization and reducing of distortion artifacts and shake leftovers may improves the sharpness of an image, resulting in higher quality photography and/or improved operations that rely on the photograph. For example, when computer visions operations are performed on the higher quality photography, the improving global stabilization and reducing distortion artifacts and shake leftovers may improve object and/or person detection and/or decisions made by a system using the photograph.

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In general, this disclosure describes image processing techniques involving digital cameras having image sensors and image signal processors (ISPs). In order to achieve improved video stabilization quality, digital image stabilization (DIS) based on image sensor motion data and non-image sensor motion data may be used to improving global stabilization and reducing distortion artifacts and shake leftovers in video that would otherwise result from camera motion. Image video stabilization techniques may be implemented in the image signal processor and/or in a CPU coupled to the image signal processor (ISP) in response to image processing functions executing on the CPU. The image signal processor may be configured to control the capture of image frames from one or more image sensors and process the image frames from one or more image sensors to generate a view of a scene in an output image frame. The output image frame may be further processed by the ISP, CPU, and/or other general-purpose or fixed-function logic circuitry within the image capture device to perform image stabilization, such as hybrid DIS and EIS image stabilization described with reference to FIG. 2, FIG. 3, FIG. 4, FIG. 5, or FIG. 6. In some aspects, the image stabilization may be performed in real-time during an image preview in a camera application executing on the image capture device. In some aspects, the image stabilization may be performed after capturing input image frames and non-image sensor motion data in non-real-time for later display to a user or saving as a photograph for viewing or sharing by the user or others. Output image frames are determined as a result of the image stabilization applied to input image frames captured from an image sensor.

After an output frame representing the scene is generated by the image signal processor, the view of the scene may be displayed on a device display, saved to a storage device as a picture or a sequence of pictures as a video, transmitted over a network, and/or printed to an output medium. For example, the image signal processor may be configured to obtain input frames of image data (e.g., pixel values) from the different image sensors, and in turn, produce corresponding output frames of image data (e.g., preview display frames, still-image captures, frames for video, etc.). In other examples, the image signal processor may output frames of the image data to various output devices and/or camera modules for further processing, such as for 3A parameter synchronization, producing a video file via the output frames, configuring frames for display, configuring frames for storage, etc. That is, the image signal processor may obtain incoming frames from one or more image sensors, each coupled to one or more camera lenses, and, in turn, may produce and output a flow of output frames to various output destinations.

In one aspect of the disclosure, a method includes receiving an input image frame, determining non-image sensor motion data corresponding to the input image frame, determining image sensor motion data corresponding to the input image frame, and/or determining a corrected image frame based, at least in part, on the input image frame, the non-image sensor motion data, and the image sensor motion data.

In some aspects, the method may include one or more of receiving a previous image frame, wherein determining the image sensor motion data is also based, at least in part, on the previous image frame; determining the image sensor motion data comprises determining at least one motion vector relating the input image frame to the previous image frame; determining the corrected image frame comprises compensating the at least one motion vector based, at least in part, on the non-image sensor motion data to generate at least one compensated motion vector, the corrected image frame being based on the at least one compensated motion vector; determining a distortion correction transform based, at least in part, on the non-image sensor motion data; receiving at least one of gyroscope data, accelerometer data, magnetometer data, focus lens position, or optical image stabilization (OIS) lens position; compensating the at least one motion vector based, at least in part, on the at least one of gyroscope data, accelerometer data, magnetometer data, focus lens position, or optical image stabilization (OIS) lens position; generating at least one rotation-compensated motion vector; generating a model based, at least in part, on the at least one compensated motion vector, wherein the model represents the translation movement and model and measurement errors; rejecting outlying motion vectors of the at least one compensated motion vector before determining the corrected image frame; and/or determining a distortion correction transform based, at least in part, on a plurality of lens positions corresponding to a plurality of portions of the input image frame.

In an additional aspect of the disclosure, an apparatus is disclosed that includes at least one processor, and a memory coupled to the at least one processor. The at least one processor is configured to perform any of the methods or techniques described herein. For example, the at least one processor may be configured to perform steps including determining non-image sensor motion data corresponding to the input image frame, determining image sensor motion data corresponding to the input image frame, and/or determining a corrected image frame based, at least in part, on the input image frame, the non-image sensor motion data, and the image sensor motion data.

The at least one processor may include an image signal processor or a processor including specific functionality for camera controls and/or processing. The at least one processor may also or alternatively include an application processor. The methods and techniques described herein may be entirely performed by the image signal processor or the application processor, or various operations may be split between the image signal processor and the application processor, and in some aspects split across additional processors.

The apparatus may include one, two, or more image sensors, including a first image sensor and a second image sensor, wherein the first image sensor has a larger field of view (FOV) than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur with a lens cluster on a mobile device, such as where multiple image sensors and associated lenses are located in offset locations on a frontside or a backside of the mobile device. Additional image sensors may be included with larger, smaller, or same field of views. The image correction techniques described herein may be applied to image frames captured from any of the image sensors in a multi-sensor device.

In an additional aspect of the disclosure, a device configured for image capture is disclosed. The apparatus includes means for receiving an input image frame, means for determining non-image sensor motion data corresponding to the input image frame; means for determining image sensor motion data corresponding to the input image frame; and/or means for determining a corrected image frame based, at least in part, on the input image frame, the non-image sensor motion data, and the image sensor motion data. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), time of flight detectors. The apparatus may further include one or more means for accumulating and/or focusing light rays into the one or more image sensors (including simple lenses, compound lenses, spherical lenses, and non-spherical lenses).

In an additional aspect of the disclosure, a non-transitory computer-readable medium stores instructions that, when executed by a processor, cause the processor to perform operations including those described in the method and techniques described herein. For example, the operations may include receiving an input image frame, determining non-image sensor motion data corresponding to the input image frame, determining image sensor motion data corresponding to the input image frame, and/or determining a corrected image frame based, at least in part, on the input image frame, the non-image sensor motion data, and the image sensor motion data.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data over a first network connection of a plurality of network connections; and a processor coupled to the first network adaptor, and the memory.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram of a computing device configured to perform one or more of the example techniques described in this disclosure.

FIG. 2 is a flow chart illustrating a method of correcting image frames for camera motion according to one or more aspects of the disclosure.

FIG. 3 is a flow chart illustrating a method of correcting image frames for camera motion using rotation-compensated motion vectors according to one or more aspects of the disclosure.

FIG. 4 is a block diagram illustrating computations involved in correcting image frames for camera motion using rotation-compensated motion vectors according to one or more aspects of the disclosure.

FIG. 5 is a block diagram for correction of intra-frame field of view changes according to one or more aspects of the disclosure.

FIG. 6 is a flow chart illustrating a method for correcting in-frame field of view changes according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image stabilization. Particular implementations of the subject matter described in this disclosure may be implemented to realize potential advantages or benefits, such as improved image quality by reducing blur to produce sharper photographs output by the image capture devices.

An example device for capturing image frames using multiple image sensors, such as a smartphone, may include a configuration of two, three, four, or more cameras on a backside (e.g., a side opposite a user display) or a front side (e.g., a same side as a user display) of the device. Devices with multiple image sensors include one or more image signal processors, Computer Vision Processors (CVPs), or other suitable circuitry for processing images captured by the image sensors. The one or more image signal processors may provide the processed image frames to a memory and/or a processor (such as an application processor, an image front end (IFE), an image processing engine (IPE), or other suitable processing circuitry) for further processing, such as for encoding or other manipulation.

As used herein, image sensor may refer to the image sensor itself and any other suitable components coupled to the image sensor. For example, an image sensor may also refer to other components of a camera, including a shutter, buffer, or other readout circuitry. The image sensor may further refer to an analog front end or other circuitry for converting analog signals to digital representations for the frame. Therefore, the term “image sensor” herein may refer to any suitable components for capture and readout of an image frame to an image signal processor.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure. Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

In the figures, a single block may be described as performing a function or functions; however, in actual practice, the function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any suitable electronic device including or coupled to two or more image sensors capable of capturing image frames (or “frames”). Further, aspects of the present disclosure may be implemented in devices having or coupled to image sensors of the same or different capabilities and characteristics (such as resolution, shutter speed, sensor type, and so on).

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

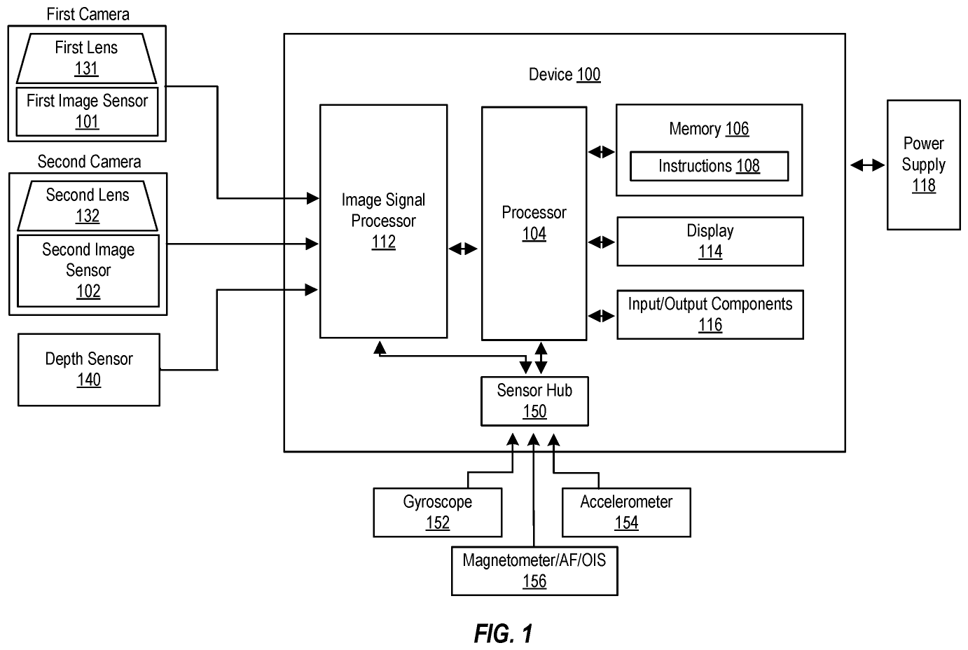

FIG. 1 shows a block diagram of an example device 100 for performing image capture from one or more image sensors. The device 100 may include, or otherwise be coupled to, an image signal processor 112 for processing image frames from multiple image sensors, such as a first image sensor 101, a second image sensor 102, and/or a depth sensor 140. In some aspects, the depth sensor 140 may include a time-of-flight sensor, light detection and ranging (LIDAR) sensor, structured light sensor, infrared (IR) sensor, or other device configured for measuring a depth to an object in the field of view of one of the image sensors 101 or 102. The device 100 may also determine depth information without a separate depth sensor 140, such as by determining depth information from a disparity between image frames with overlapping scenes captured by the image sensors 101 and 102, and or between one of image sensors 101 and 102 and other image sensors. In some implementations, the device 100 also includes or is coupled to a processor 104 and a memory 106 storing instructions 108. The device 100 may also include or be coupled to a display 114 and a number of input/output (I/O) components 116, such as a touch screen interface and/or physical buttons. The device 100 may further include or be coupled to a power supply 118 for the device 100, such as a battery or a component to couple the device 100 to an energy source. The device 100 may also include or be coupled to additional features or components not shown. In one example, a wireless interface, which may include a number of transceivers and a baseband processor, may be included for a wireless communication device. In another example, one or more other sensors (such as a global positioning system (GPS) receiver) may be included in or coupled to the device. In a further example, an analog front end to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-image sensor data. Such non-image sensors may be integrated in the device 100 and/or coupled to the device 100. One example non-image sensor is a gyroscope 152. The gyroscope 152 may be a device configured for measuring rotation, orientation, and/or angular velocity. Another example non-image sensor is an accelerometer 154. The accelerometer 154 may be a device configured to measuring acceleration, which may also be used to determine velocity and distance traveled by appropriately integrated the measured acceleration. Other non-image sensors 156 may be included in the device 100, such as a magnetometer, auto-focus (AF) system, and/or optical image stabilization (OIS) device. In some aspects, the gyroscope 152 and/or accelerometer 154 may be microelectromechanical systems (MEMS). The device 100 may be configured to sample the gyroscope 152, the accelerometer 154, and/or other sensors to obtain non-image sensor data during capture of image frames by one or more of the image sensors 101 and 102. Such non-image sensor data may be used by the device 100 to perform optical image stabilization (OIS), electronic image stabilization (EIS), and/or digital image stabilization (DIS) on the captured image frames. OIS, EIS, and/or DIS may be applied in different aspects of this disclosure to compensate for camera motion and reduce blur in photographs captured by the device 100.

Using OIS, the device 100 may move one or more components of a camera to compensate for camera motion. For example, a device may move the camera lens to counteract a user's hand shaking during video capture. The device 100 may move the camera lens 131 and/or 132 to counteract a user's hand shaking during video capture based on measurements from the gyroscope 152 using lens shift or module tilt. The lens shift may be performed using magnets, mechanical means (e.g., a pushing or pulling mechanism) and/or an electrical means (e.g., electrical charge application).

Using EIS, the device 100 may perform processing of the image frames to reduce one or more motion distortions during capture. In one aspect, EIS may compensate for a camera's global motion to reduce shakiness in the video. EIS may also be used to reduce distortions caused by a rolling shutter. As used herein, EIS may also refer to a reduction in lens distortions (such as a transform or mapping of pixels to de-warp the captured frame). In some examples of EIS to reduce global motion, a size of each final image in the final image stream for a video may be smaller than the size of the frames being captured by the camera sensor. For example, a device may crop a portion (such as 10 percent) of each of the captured frames (with the cropping location moving based on the global motion) to generate a final, processed stream of images that are a fraction in pixel size of the frames captured by the camera sensor. As noted, the cropping window may be shifted to compensate for camera motion. For example, if the camera moves from left to right, the cropping window may move from right to left in the captured frames. A frame may also be rotated, stretched, or otherwise adjusted to compensate for rotation motion.

Using DIS, captured image frames may be used to correct camera motion during capture of an image frame. For example, image sensor motion data may be determined by comparing different image frames captured from the image sensor. The comparison may include identifying features in the image frames and determining a shift of the feature from one image frame to another image frame. This image sensor motion data may be used in processing of a captured image frame to provide image stabilization by providing information regarding camera motion during the capture of the image frame. DIS, based on image sensor motion data, may be combined with EIS and/or OIS, based on non-image sensor motion data, to provide better image stabilization for captured image frames and improved image quality by reducing motion blur.

The image signal processor 112 may receive image data from a local bus connection to image sensors or by other connections, such as a wire interface to an external image sensor or wireless interface to a distant image sensor. In some embodiments, the device 100 may include a first camera comprising the first image sensor 101 and corresponding first lens 131 and a second camera comprising the second image sensor 102 and corresponding second lens 132. Each of the first and second cameras may include first and second auto-focus (AF) systems that move the first lens 131 and the second lens 132, respectively, to focus the first and second cameras at a desired focal plane, such as a focal plane corresponding to a detected object. In some embodiments, the device 100 may include an interface to receive image data from the image sensors 101 and 102 when located apart from the device 100, such as through a wireless connection. The device 100 may perform image processing on the image data from a combination of image sensors located within the device 100 or separate from the device 100.

The first image sensor 101 and the second image sensor 102 are configured to capture one or more image frames. For example, the first image sensor 101 and the second image sensor 102 may be included in one multiple camera configuration or in separate single cameras or separate multiple camera configurations (such as a dual camera configuration, a triple camera configuration, and so on, for a smartphone or other suitable device). The image sensors 101 and 102 may also include or be coupled to one or more lenses for focusing light, one or more apertures for receiving light, one or more shutters for blocking light when outside an exposure window, one or more color filter arrays (CFAs) for filtering light outside of specific frequency ranges, one or more analog front ends for converting analog measurements to digital information, or other suitable components for imaging. For example, the first image sensor 101 may be coupled to a first lens 131 and the second image sensor 102 may be coupled to a second lens 132. The first lens 131 and second lens 132 may have different field of views, such as when the first lens 131 is an ultra-wide (UW) lens and the second lens 132 is a wide (W) lens. The device 100 may also include or be coupled to a flash, a depth sensor, a GPS, or other suitable components for imaging.

The multiple image sensors may include a combination of ultra-wide (high field-of-view (FOV)), wide, tele, and ultra-tele (low FOV) sensors. That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees. Some aspects of the disclosure include processing the captured image frames, such as by adjusting spatial alignment of one or more of the captured image frames while the device transitions from capturing images of a scene using a first of the multiple image sensors to capturing images of the scene using a second of the multiple image sensors. Aspects of the present disclosure may be used for capturing image frames using multiple image sensors of an image capture device. For example, the image sensor motion data used for digital image stabilization (DIS) may be acquired using a combination of image frames from multiple image sensors.

The image signal processor 112 processes image frames captured by the image sensors 101 and 102. While FIG. 1 illustrates the device 100 as including two image sensors 101 and 102 coupled to the image signal processor 112, any number of image sensors may be coupled to the image signal processor 112. In addition, any number of additional image sensors or image signal processors may exist for the device 100. In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may execute software and/or may include specific hardware (such as one or more integrated circuits (ICs)) to perform one or more operations described in the present disclosure.

In some implementations, the memory 106 may include a non-transient or non-transitory computer readable medium storing computer-executable instructions 108 to perform all or a portion of one or more operations described in this disclosure. In some implementations, the instructions 108 include a camera application (or other application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to the memory and configured to access the memory for writing output frames for display or long-term storage.

In some embodiments, the processor 104 may include one or more general purpose processors capable of executing scripts or instructions of one or more software programs, such as instructions 108 stored within the memory 106. For example, the processor 104 may include one or more application processors configured to execute the camera application (or other suitable application for generating images or video) stored in the memory 106. In executing the camera application, the processor 104 may be configured to instruct the image signal processor 112 to perform one or more operations with reference to the image sensors 101 or 102. For example, the camera application may receive a capture command upon which an image frame is captured and processed through one or more methods described herein for improving image quality through image stabilization. Execution of instructions 108 outside of the camera application by the processor 104 may also cause the device 100 to perform any number of functions or operations. In some embodiments, the processor 104 may include ICs or other hardware in addition to the ability to execute software to cause the device 100 to perform a number of functions or operations, such as the operations described herein. In some other embodiments, the device 100 does not include the processor 104, such as when all of the described functionality is configured in the image signal processor 112.

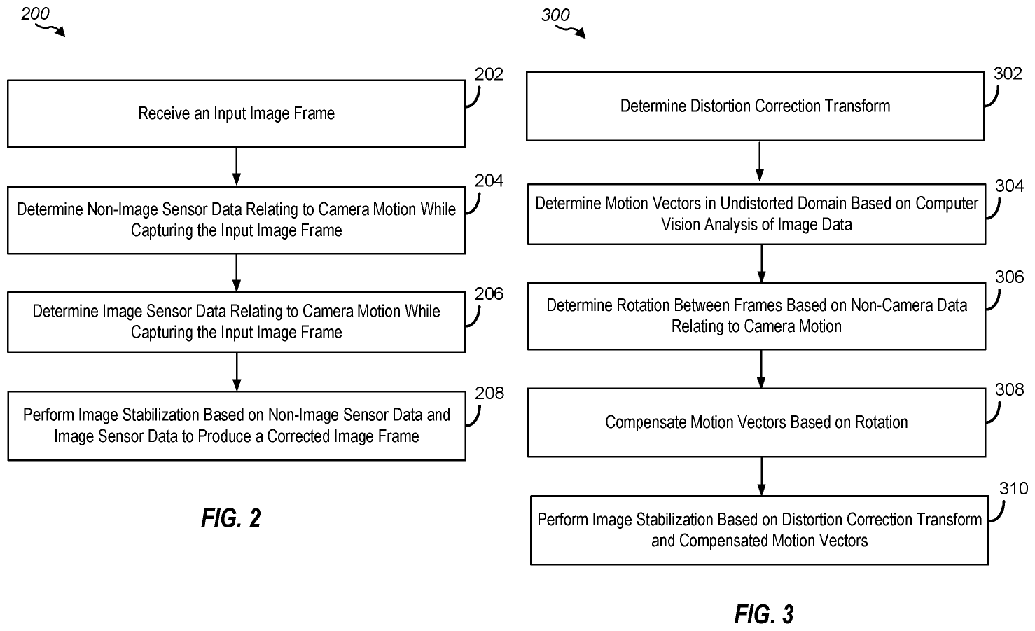

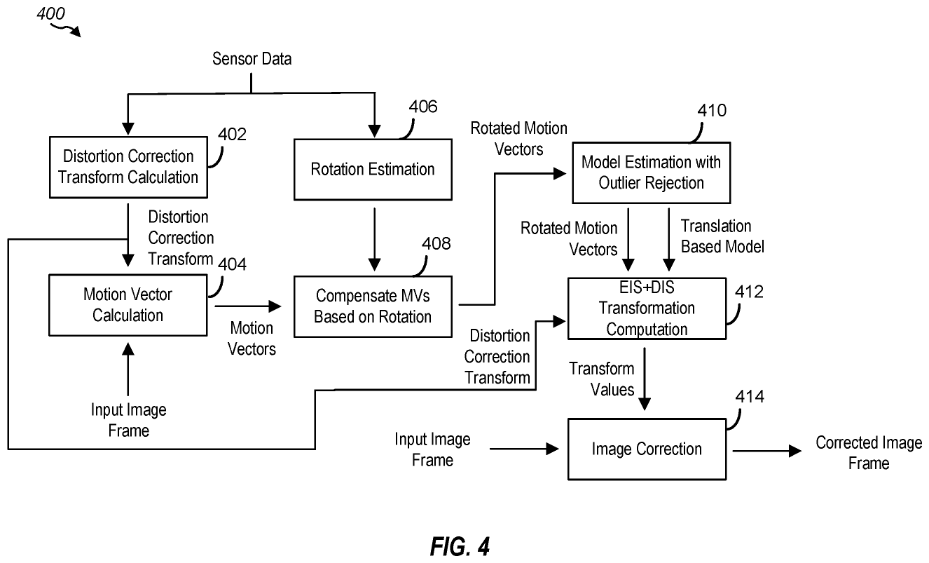

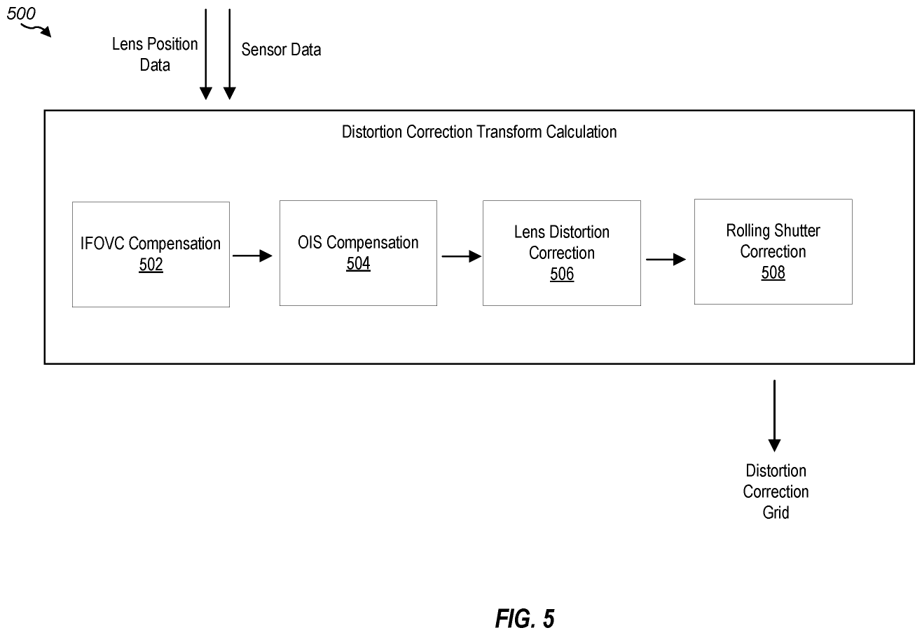

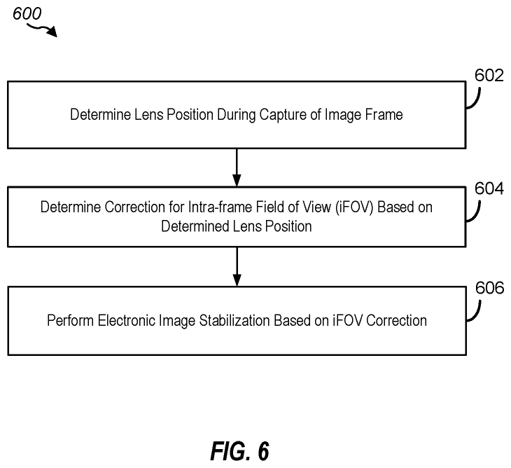

In some embodiments, at least one of the image signal processor 112 or the processor 104 can execute instructions to perform various operations described herein. For example, execution of the instructions can instruct the image signal processor 112 to begin or end capturing an image frame. As another example, execution of the instructions can instruct the image signal processor 112 to change from capturing a first image of a scene captured using the first image sensor 101 to a second image of the scene captured using the second image sensor 102. As a further example, execution of the instructions can instruct the image signal processor 121 to activate or deactivate digital image stabilization (DIS), such as described in FIG. 2, FIG. 3, FIG. 4, FIG. 5, or FIG. 6.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user. For example, the I/O components 116 may include (but are not limited to) a keyboard, a mouse, a microphone, speakers, a squeezable bezel, one or more buttons (such as a power button), a slider, a switch, and so on, to provide interaction to the device 100, such as through a graphical user interface (GUI).

While shown to be coupled to each other via the processor 104, the processor 104, the memory 106, the image signal processor 112, the display 114, and the I/O components 116 may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

EIS may also provide for correction of distortion within the image frame itself, distortions that may be caused by rolling shutter, lens distortion, changing focus position, and/or OIS movement. EIS conventionally detects motion for compensation by electronic processing of image data using a gyroscope. However, a gyroscope does not provide complete information regarding camera motion, which results in incomplete detection of camera motion and thus incomplete compensating adjustments to correct for camera motion. Image capture devices may also include optical image stabilization (OIS) that address movement during exposure of an image by moving the lens or sensor at the opposite direction of user movement and canceling out the cause for the motion blur. However, OIS may insert errors to stabilization due to incorrect and/or noisy OIS position data that is shared with the EIS algorithm.

Shortcomings mentioned here are only representative and are included to highlight problems that the inventors have identified with respect to existing devices and sought to improve upon. Aspects of devices described below may address some or all of the mentioned shortcomings, such as improving global stabilization and photograph quality and sharpness, as well as others known in the art. Aspects of the improved devices described below may present other benefits than, and be used in other applications than, those described herein.

Digital image stabilization (DIS) may be implemented in an image capture device to address some or all above problems of local stabilization and in-frame distortions alone or in combination with electronic image stabilization (EIS) to reduce artifacts, shake leftovers, and other problems resulting from insufficient global stabilization. DIS may use image sensor motion data derived from image-based information, such as motion vectors between frames, to modify captured image data to generate corrected image frames having improved global stabilization and reduced distortion artifacts and shake leftovers resulting from camera motion. The image sensor motion data may be used in combination with non-image sensor motion data, such as data from a gyroscope an optical image stabilization (OIS) device, a magnetometer, an accelerometer, and/or auto-focus (AF) feedback to perform image stabilization. One aspect of performing digital image stabilization (DIS) is described with reference to FIG. 2. FIG. 2 is a flow chart illustrating a method 200 of correcting image frames for camera motion according to one or more aspects of the disclosure. The method 200 may perform image stabilization based on non-image data, which may be referred to as electronic image stabilization (EIS), in combination with image stabilization based on image data in combination with non-image data, which may be referred to as digital image stabilization (DIS).

A method 200 begins at block 202 with receiving an input image frame. The input image frame may be received from an image sensor at an image signal processor. The image sensor may be, for example, a forward-facing or rear-facing sensor of a mobile device, a sensor of a digital camera device, or an image frame fused from multiple sensors with overlapping fields of view. The input image frame may have a corresponding timestamp, or other identifying data, that facilitates identification of non-image sensor data corresponding to the input image frame. Non-image sensor data may correspond to the image sensor data when the non-image sensor data reflects, estimates, or otherwise corresponds to motion at the time the image sensor data is captured. The input image frame may alternatively or also be received at a processor remote from the image capture device for processing, such as determining of a corrected image frame from the input image frame.

At block 204, the method 200 includes determining non-image sensor motion data corresponding to the input image frame. Non-image sensor motion data includes data regarding motion of the device obtained from sources other than the image sensor. The non-image sensor motion data may include gyroscope data describing rotational movement of the image capture device corresponding to the input image frame captured at block 202. The non-image sensor motion data may have corresponding timestamps to facilitate matching of the non-image sensor motion data to individual input image frames and/or portions of an input image frame. The determining of the non-image sensor motion data may include receiving the non-image sensor data and/or identifying that certain non-image sensor data is associated with camera motion occurring during the capture of the input image frame that is received at block 202.

At block 206, the method 200 includes determining image sensor motion data corresponding to the input image frame. The motion data may be based, at least in part, on the input image frame, such as when the motion data is a motion vector comparing the input image frame to another image frame. Image sensor motion data includes data regarding motion of the device obtained from the image sensor. The image sensor motion data may be determined based on a previous image frame captured by the image capture device, such as a previous image frame captured by the image sensor that generated the input image frame at block 202 or another image sensor with a similar field of view. A motion vector may be used to represent this image sensor motion data, and the motion vector may be determined based on the input image frame and the previous image frame. The motion vectors may be determined using computer vision (CV) processing for identifying corresponding features in the image frames and determining a shift of the identified features from one frame to another frame. The CV processing may be performed in fixed-function or other general-purpose logic circuitry coupled to the ISP or embedded in the ISP. The image sensor motion data may also or alternatively be determined based on a previous motion vector corresponding to one or more image frames captured by the image capture device. The determining of the image sensor motion data may include receiving the camera data and/or identifying that certain camera data is associated with camera motion occurring during the capture of the input image frame that is received at block 202. The determining of the image sensor motion data may also or alternatively include calculating a value, such as estimating camera motion from a previous motion vector derived from a previous image frame captured by an image sensor.

At block 208, the method 200 includes determining a corrected image frame based, at least in part, on the input image frame, the non-image sensor motion data, and the image sensor motion data. In some aspects, the corrected image frame may be generated by compensating motion vectors of the image sensor motion data, with the compensated motion vectors used in performing image stabilization using the compensated motion vectors. For example, digital image stabilization (DIS) may be applied to the input image frame based on the compensated motion vectors to remove translation motion occurring during capture of the input image frame received at block 202. The corrected image frames may represent a video having improved global stabilization and reducing distortion artifacts and shake leftovers and higher image quality by compensating for image capture device translation and other errors not handled by EIS. In some aspects, the image stabilization performed at block 208 may also include electronic image stabilization (EIS) based on the non-image sensor data of block 204. DIS can use image-based motion vectors with regard to previous frame or can use other motion vectors with regards to other frames, such as image vectors computed from frames previous to or after the current image frame being processed.

In one aspect of performing image stabilization using image data, the image video stabilization may include determining motion vectors compensated based on non-image sensor data relating to camera motion. FIG. 3 is a flow chart illustrating a method 300 of correcting image frames for camera motion using rotation-compensated motion vectors according to one or more aspects of the disclosure. The method 300 may perform processing occurring during blocks 206 and/or 208 of method 200.

At block 302, a distortion correction transform may be determined based on sensor data, such as gyroscope data, reflecting non-image sensor motion data. The distortion correction transform may be determined to correct for one or more of OIS, LDC, and/or RSC. The distortion correction transform may be determined prior to motion vector calculation such that the input image frame may be transformed to an undistorted domain prior to the motion vector calculation.

At block 304, motion vectors may be determined in an undistorted domain based on computer vision (CV) analysis of the image data. The determined motion vectors may relate the input image frame to the previous image frame. The undistorted domain for the input image frame may be determined by using the non-image sensor motion data to adjust the input image frame to the undistorted domain by reducing or eliminating distortion by use of RSC, LDC, OIS, and/or focus changes. In some aspects, computer vision (CV) processing may be performed to identify matching features between the previous image frame and the input image frame, and the motion vector determined as a difference between a first location of the feature in the previous image frame and a second location of the feature in the input image frame. In some aspects, the comparing of the previous image frame and the input image frame may be based on homography using a modified weighted least squares and/or filtration.

The CV processing may also produce metadata to accompany the motion vectors, such as a confidence score for each motion vector that may be used in generating a translation model and/or determining outlying motion vectors.

At block 306, a rotation may be determined between frames based on non-image sensor data relating to camera motion. For example, gyroscope data with timestamps corresponding to the input image frame being processed may be processed to determine rotational movement occurring during capture of the input image frame, occurring around the time of the input image frame (such as within a predetermined number of image frames), prior to the time of the input image frame (such as during an image frame prior to the input image frame being processed), or otherwise corresponding to the input image being processed such that the determined rotational movement is an approximation of the rotational movement during capture of the input image frame.

At block 308, the motion vectors of block 304 may be compensated based on the determined rotation of block 306. The compensated motion vectors may represent only the translation and measurement errors because they have been compensated by rotational movement from gyroscope data and/or other distortion corrections such as RSC, LDC, OIS, and/or focus changes.

Motion vectors were determined in the undistorted domain (after correction of, e.g., rolling shutter, lens distortion, iFOVC, OIS) at block 304, and then compensated by rotation movement between frames at block 308. Thus, compensated motion vectors containing components of only translational movement (displacement in three-dimensional world) and/or leftovers caused by model and measurements errors. These compensated motion vectors may be used to generate a homography matrix used to correct shake leftovers resulting only by translational movement and leftovers caused by model and measurements errors. This differs from conventional motion vectors and conventional homography matrix that are used to describe all causes of movement during image capture. The rotational movement may be performed with high accuracy and the rotated motion vectors used to remove leftovers that the rotational model does not address.

At block 310, the image stabilization may be performed based on the distortion correction transform of block 302 and/or the compensated motion vectors of block 308. This digital image stabilization (DIS) may be combined with other image stabilization techniques such as electronic image stabilization (EIS) and/or optical image stabilization (OIS), which may or may not use the non-image sensor motion data.

One example system for the generation of a corrected image frame based on EIS and DIS through various modules is shown in FIG. 4. FIG. 4 is a block diagram illustrating computations involved in correcting image frames for camera motion using rotation-compensated motion vectors according to one or more aspects of the disclosure. A system 400 may include various modules for performing certain functions. The modules may be computer software program code executing on general-purpose logic circuitry or fixed-function hardware or a mix of general-purpose logic circuitry and fixed-function hardware. In some aspects, the various modules may share program code and/or execute on the same general-purpose logic circuitry as other modules in the system 400.

A motion vector calculation module 404 may receive an input image frame and determine motion vectors, such as by comparing the input image frame to a previous image frame. In some aspects, the module 404 may execute, in part, on a computer vision (CV) processor coupled to an image signal processor (ISP), in which the ISP determines the motion vectors based on output from the CV processor.

The motion vector calculation module 404 may determine the motion vectors based on the distortion correction transform produced by module 402, such that the motion vectors output from module 404 are determined in an undistorted domain. Sensor data may be received from sensors other than image sensors, such other sensors include a gyroscope data, accelerometer data, compass data, magnetometer data, auto-focus (AF) lens position data, and/or optical image stabilization (OIS) lens position data. The sensor data may be used in a distortion correction transform calculation module 402 to generate a distortion correction transform.

A rotation estimation module 406 may determine rotation motion of the image capture device capturing the input image frame. The rotation estimation may be based on some or all of the sensor data, such as gyroscope data, used for the distortion correction transform calculation at module 402. The rotation estimate may be provided to a motion vector compensation module 408, which also receives the motion vectors in the undistorted domain from the motion vector calculation module 404. The motion vector compensation module 408 may determine compensated motion vectors that are the undistorted domain motion vectors rotated based on the rotation estimate of the image capture device. These rotated motion vectors may represent only the translation and measurement errors because they have been compensated by rotational movement from gyroscope data and distortion corrections from RSC, LDC, OIS, and/or focus changes.

A model may be generated from the rotated motion vectors from module 408 that reflects the translational movement between two frames, current and previous image frames. The translation model approximates a translational movement that can be corrected to improve global stabilization and reduce distortion artifacts and shake leftovers. A model estimation module 410 may receive the rotated motion vectors and determine a translation-based model based on the rotated motion vectors. The model estimation module 410 may also reject outlier motion vectors determined based on the translation model. The model estimation module 410 may output inlier rotated motion vectors and parameters reflecting the translation-based model to a transformation computation module 412. In some aspects, the model estimation module 410 may execute a random sample consensus (RANSAC) model or another model estimation and outliers rejection method on the rotation-compensated motion vectors. Random sample consensus (RANSAC) is an iterative method to estimate parameters of a mathematical model from a set of observed data that contains outliers, when outliers are to be accorded no influence on the values of the estimates. The model estimation module 410 may generate a model using three parameters, including a translation x (“tx”) parameter, a translation y (“ty”) parameter, and a translation z (“tz”) parameter. Fewer parameters, such as two parameters, may be used to model two-dimensional translations. The model may include only three parameters by operating on the rotation-compensated motion vectors with rotation components compensated by the non-image sensor data. A model generated from non-rotation-compensated motion vectors may require additional parameters to model camera motion during capture of the image frame. For example, a model from non-rotation-compensated motion vectors may include a translation x (“tx”) parameter, a translation y (“ty”) parameter, a translation z (“tz”) parameter, an alpha (α) rotation angle, a beta (β) rotation angle, and a gamma (γ) rotation angle. These parameters may reflect, for example, aspects of distortion artifacts and shake leftovers caused by a user moving while taking a photograph, such as running alongside an object, and/or blur caused by a user who is unsteady while taking a photograph, such as caused by a shaky hand. Thus, the compensation of motion vectors in module 408 to obtain rotated motion vectors that reflect only translation and/or measurement errors may simplify processing compared to other translation compensation techniques involving the image sensor motion data.

The output of the transformation computation module 412 may be a set of transform values used by image correction module 414 to generate a corrected image frame from an input image frame. The corrected image frame may be displayed to a user, recorded to a storage device, or otherwise consumed by a user or another application. The corrected image frame may have improved image quality resulting from the EIS and DIS reflected in the transform values received from module 412. The module 412 may adjust the distortion correction transform values from module 402 based on the translation-based model and/or the rotated motion vectors to obtain transform values for output from the module 412 that reflects EIS and/or DIS corrections. The DIS contribution to the transform values, resulting from processing in modules 404, 408, 410, and/or 412 may remove or reduce shake leftovers in video. The EIS contribution to the transform values, resulting from processing in modules 402 and/or 412, may remove or reduce rotation-related shake. Mobile devices implementing some or all of the processing described with reference to FIG. 2, FIG. 3, and/or FIG. 4 may have image stabilization that produces higher quality image than conventional EIS and/or in more scenes. This combination of DIS and EIS processing may include full support with EIS distortion correction (e.g., RSC, OIS, iFOVC, and/or LDC) and may include full support with EIS global stabilization.

During capture of an image frame, the field of view of the image sensor may change. For example, the image frame captured may have different lines of the image captured at different field of views when an autofocus (AF) system is changing the lens position to reach a target focal distance. The result may be an image frame with a non-even zoom. As another example, when an autofocus (AF) system is changing the lens position to track an object in the scene, the image frame captured may have different lines of the image captured at different field of views resulting in the image frame having a non-even zoom. An intra-frame focus distance may be determined for portions of the image frame and used to correct the non-even zoom in the image frame and remove or reduce field-of-view distortion.

Focus field-of-view (FOV) correction is a method performed to current the FOV change that is caused by change of camera focus. The change can happen during a frame capture leading to a distorted object with varying size and shape in the frame. When this occurs during an image frame capture that is used as part of a video, the video may exhibit a wobble in and between the frames. Intra FOVC (iFOVC) may be used to correct these distortions that occur within an image frame. In one aspect of a distortion correction transform calculation that may be implemented in module 402, the distortion correction transform may include intra-frame field of view (iFOVC) correction. An example system for distortion correction transform calculation with iFOVC correction is shown in FIG. 5. FIG. 5 is a block diagram for correction of in-frame field of view changes according to one or more aspects of the disclosure.

A distortion correction transform calculation module 500 may receive non-image sensor data, such as gyroscope data, and lens position data, such as an actual lens position and/or estimated lens position. The transform calculation module 500 may perform iFOVC correction in module 502 using the lens position data to generate a distortion correction grid that, when applied to the input image frame captured at a time corresponding to the lens position data, reduces or removes non-even zoom in the captured image frame. The iFOVC of module 502 may be performed, for example, in the image signal processor 112 and/or the processor 104 of the device 100 shown in FIG. 1. In some aspects, the iFOVC may include using a calibration video created prior to application of the correction to generate a function corresponding to a change in FOV as a function of the focus distance. For each input image frame, a focus position is determined from the function to scale focus units of the input image frame into a field of view (FOV) so that when focus is locked on infinity no FOV will be lost, such as by using a scaling factor of 1. When focus is locked on a close object, downscale may be applied to adjust the FOV by taking from EIS margins. In some aspects, this scaling may result in no loss of FOV. The adjustments may be applied to the distortion correct grid output by module 500. In some aspects, an iFOVC scale may be calibrated by performing a focus scan and subsequently determining a scale between a FOV of some focus point and a FOV of infinity focus. The scale may be determined for each image frame line according to focus lens position for that line and based on the infinity focus FOV point. The correction is done by compensating the scale in the distortion correction process.

The distortion correction grid generated by iFOVC compensation module 502 may be adjusted based on one or more other corrections. For example, the distortion correction grid may be adjusted based on optical image stabilization (OIS) compensation in module 504, which may use non-image sensor data, such as gyroscope data, to improve global stabilization during video capture. As another example, the distortion correction grid may be adjusted based on lens distortion correction in module 506. The lens distortion correction may be performed based on predetermined parameters corresponding to a lens used to capture the image frame being processed to remove or reduce distortion from lens shape such as pincushion distortion or barrel distortion. As a further example, the distortion correction grid may be adjusted based on rolling shutter correction in module 508. Adjustments to the distortion correction grid in module 508 may remove image warping produced by intra-frame field of view changes during sequential read-out of rows and/or columns of the image sensor. The distortion correction grid output by the calculation module 500 may be used in processing of an input image frame, such as in the system of FIG. 4 when generating motion vectors in an undistorted domain at module 404, determining image stabilization transform values at module 412, and/or performing image stabilization in image correction module 414.

Field of view (FOV) changes may also affect system parameters applied as part of image stabilization, such as focal length, LDC, OIS parameters, and/or others. EIS parameters may be determined for a focal distance of infinity and when the focal distance is different from infinity these parameters become inaccurate. Compensating for iFOVC scale issues to reduce or remove the non-even zoom may also make the other parameters invariant for focus changes and FOV changes. This results in an improvement of distortion correction and global stabilization, and a subsequent improvement in image sharpness.

The iFOVC correction described with reference to FIG. 5 may be used as part of an image stabilization technique on an image frame captured from an image capture device. FIG. 6 is a flow chart illustrating a method for correcting in-frame field of view changes according to one or more aspects of the disclosure. A method 600 begins at block 602 with determining lens movement, such as a lens position as a function of time, during capture (e.g., frame readout) of an input image frame. In one aspect, the lens movement may be determined based on feedback from the autofocus (AF) system corresponding to the image sensor capturing the image frame. In one aspect, the lens movement may be determined in real-time based on lens position data received from an AF controller. In one aspect, the lens movement may be determined based on an estimated focus position corresponding to the lens position, such as the last focus position signaled to the AF controller in an instruction to focus at the focus position. The estimation may be determined, for example, based on a known movement speed and/or a starting lens position at the beginning of a frame readout. The determination of lens position during frame readout from an image sensor may result in a plurality of lens positions corresponding to a lens position during readout of separate portions of the input image frame. In one aspect, the lens positions determined at block 602 may have timestamps or other information that allow the lens positions to be correlated with portions of an input image frame.

At block 604, a correction is determined for intra-frame field of view (iFOV) based on the determined lens position(s) of block 602. For example, a distortion correction transform may include a distortion correction grid, and individual rows, columns, or other portions of the grid may be adjusted based on lens position data corresponding to the time the individual row was captured at the image sensor. The distortion correction transform may be based, at least in part, on a plurality of lens positions corresponding to a plurality of portions of the input image frame.

At block 606, image stabilization may be performed based on the iFOV correction (iFOVC) of block 604. The output of image stabilization of block 606 is a corrected image frame that may be used in a similar manner to the corrected image frame from image correction module 414 in FIG. 4. The image stabilization may be performed by correcting an input image frame based, at least in part, on a distortion correction transform, such as a distortion correction grid, and the distortion correction grid may include corrections for iFOV and one or more other corrections, such as OIS, RSC, and/or LDC.

In one or more aspects, techniques for supporting image capture with reduced blur may include additional aspects, such as any single aspect or any combination of aspects described below or in connection with one or more other processes or devices described elsewhere herein. In one or more aspects, supporting digital image stabilization (DIS) may include an apparatus configured to receive an input image frame. The apparatus is further configured to determine non-image sensor motion data corresponding to the input image frame. The apparatus is further configured to determine image sensor motion data corresponding to the input image frame. The apparatus is further configured to determine a corrected image frame based, at least in part, on the input image frame, the non-image sensor motion data, and the image sensor motion data. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a first aspect, the apparatus is configured to receive a previous image frame. The apparatus is further configured to determine the image sensor motion data based, at least in part, on the previous image frame.

In a second aspect, in combination with the first aspect, the apparatus may also be configured to determine the image sensor motion data includes determining at least one motion vector relating the input image frame to the previous image frame.

In a third aspect, in combination with one or more of the first aspect or the second aspect, the apparatus may also be configured to determine the corrected image frame includes compensating the at least one motion vector based, at least in part, on the non-image sensor motion data to generate at least one compensated motion vector, the corrected image frame being based on the at least one compensated motion vector.

In a fourth aspect, in combination with one or more of the second aspect through the third aspect, the apparatus is configured to determine a distortion correction transform based, at least in part, on the non-image sensor motion data.

In a fifth aspect, in combination with one or more of the second aspect through the fourth aspect, the apparatus is configured to determine the at least one motion vector is based, at least in part, on the input image frame and the distortion correction transform.

In a sixth aspect, in combination with one or more of the second aspect through the fifth aspect, the apparatus is configured to receive non-image sensor motion data includes receiving at least one of gyroscope data, accelerometer data, magnetometer data, focus lens position, or optical image stabilization (OIS) lens position. Compensating the at least one motion vector may be based, at least in part, on the at least one of gyroscope data, accelerometer data, magnetometer data, focus lens position, or optical image stabilization (OIS) lens position.

In a seventh aspect, in combination with the sixth aspect, the apparatus is configured to compensate the at least one motion vector by compensating the at least one motion vector based, at least in part, on the at least one of gyroscope data, accelerometer data, magnetometer data, focus lens position, or optical image stabilization (OIS) lens position to generate at least one rotation-compensated motion vector.

In an eighth aspect, in combination with one or more of the second aspect through the seventh aspect, the at least one compensated motion vector represents translation movement and model and measurements errors. Determining the corrected image frame includes generating a model based, at least in part, on the at least one compensated motion vector. The model represents the translation movement and model and measurement errors. Determining the corrected image frame is based on the translation-based model.

In a ninth aspect, in combination with the eighth aspect, the apparatus is configured to reject outlying motion vectors of the at least one compensated motion vector before determining the corrected image frame. The corrected image frame is based on the at least one compensated motion vector remaining after rejecting outlying motion vectors.

In a tenth aspect, alone or in combination with one or more of the first aspect through the ninth aspect, the apparatus is configured to determine a distortion correction transform based, at least in part, on a plurality of lens positions corresponding to a plurality of portions of the input image frame.

In an eleventh aspect, alone or in combination with one or more of the first aspect through the tenth aspect, the apparatus is configured to determine the corrected image frame based, at least in part, on the distortion correction transform.

In a twelfth aspect, in combination with one or more of the tenth aspect through the eleventh aspect, determining the corrected image frame based on the plurality of lens positions corrects intra-frame field of view changes due to the plurality of lens positions.

In one or more aspects, techniques for supporting image capture may include additional aspects, such as any single aspect or any combination of aspects described below or in connection with one or more other processes or devices described elsewhere herein. In one or more aspects, supporting image capture may include an apparatus including a processor. The apparatus further includes a memory coupled to the processor and storing instruction that, when executed by the processor, cause the device to perform operations including receiving an input image frame. The apparatus is further configured to determine non-image sensor motion data corresponding to the input image frame. The apparatus is further configured to determine image sensor motion data corresponding to the input image frame. The apparatus is further configured to determine a corrected image frame based, at least in part, on the input image frame, the non-image sensor motion data, and the image sensor motion data. Additionally, the apparatus may perform or operate according to one or more aspects as described below. In some implementations, the apparatus includes a wireless device, such as a mobile phone, tablet computing device, laptop computing device, point-and-shoot camera, or digital camera. In some implementations, the apparatus may include at least one processor, and a memory coupled to the processor. The processor may be configured to perform operations described herein with respect to aspects of the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a thirteenth aspect, the instructions cause the device to perform operations including receiving a previous image frame. Determining the image sensor motion data may be based, at least in part, on the previous image frame.

In a fourteenth aspect, in combination with the thirteenth aspect, the instructions cause the device to perform operations including determining the image sensor motion data includes determining at least one motion vector relating the input image frame to the previous image frame.

In a fifteenth aspect, in combination with one or more of the thirteenth aspect through the fourteenth aspect, the instructions cause the device to perform operations including determining the corrected image frame includes compensating the at least one motion vector based, at least in part, on the non-image sensor motion data to generate at least one compensated motion vector, the corrected image frame being based on the at least one compensated motion vector.

In a sixteenth aspect, in combination with one or more of the fourteenth aspect through the fifteenth aspect, the instructions cause the device to perform operations including determining a distortion correction transform based, at least in part, on the non-image sensor motion data.

In a seventeenth aspect, in combination with the sixteenth aspect, determining the at least one motion vector is based, at least in part, on the input image frame and the distortion correction transform.

In an eighteenth aspect, in combination with one or more of the fourteenth aspect through the seventeenth aspect, receiving non-image sensor motion data includes receiving at least one of gyroscope data, accelerometer data, magnetometer data, focus lens position, or optical image stabilization (OIS) lens position. Compensating the at least one motion vector is based, at least in part, on the at least one of gyroscope data, accelerometer data, magnetometer data, focus lens position, or optical image stabilization (OIS) lens position.

In a nineteenth aspect, in combination with the eighteenth aspect, compensating the at least one motion vector includes compensating the at least one motion vector based, at least in part, on gyroscope data to generate at least one rotation-compensated motion vector.

In a twentieth aspect, in combination with one or more of the fourteenth aspect through the nineteenth aspect, the at least one compensated motion vector represents translation movement and model and measurements errors.

Determining the corrected image frame includes generating a model based, at least in part, on the at least one compensated motion vector. The model represents the translation movement and model and measurement errors. Determining the corrected image frame is based on the camera motion model.

In a twenty-first aspect, in combination with the twentieth aspect, the instructions cause the device to perform operations further including rejecting outlying motion vectors of the at least one compensated motion vector before determining the corrected image frame. The corrected image frame is based on the at least one compensated motion vector remaining after rejecting outlying motion vectors.

In a twenty-second aspect, alone or in combination with one or more of the thirteenth aspect through the twenty-first aspect, the instructions cause the device to perform operations further including determining a distortion correction transform based, at least in part, on a plurality of lens positions corresponding to a plurality of portions of the input image frame.

In a twenty-third aspect, in combination with the twenty-second aspect, determining the corrected image frame is based, at least in part, on the distortion correction transform.

In a twenty-fourth aspect, in combination with one or more of the twenty-second aspect through the twenty-third aspect, determining the corrected image frame based on the plurality of lens positions corrects intra-frame field of view changes due to the plurality of lens positions.

In one or more aspects, techniques for supporting image capture may include additional aspects, such as any single aspect or any combination of aspects described below or in connection with one or more other processes or devices described elsewhere herein. In one or more aspects, supporting image capture may include an apparatus configured to a first image sensor. The apparatus is further configured to a first lens coupled to the first image sensor. The apparatus is further configured to an image signal processor coupled to the first image sensor and configured to perform operations including receiving an input image frame from the first image sensor. The apparatus is further configured to determining non-image sensor motion data corresponding to the input image frame. The apparatus is further configured to determining image sensor motion data corresponding to the input image frame. The apparatus is further configured to determining a corrected image frame based, at least in part, on the input image frame, the non-image sensor motion data, and the image sensor motion data. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twenty-fifth aspect, the image signal processor is further configured to perform operations including receiving a previous image frame. The determining the image sensor motion data is also based, at least in part, on the previous image frame.

In a twenty-sixth aspect, in combination with the twenty-fifth aspect, the apparatus is configured to a computer vision (CV) processor coupled to the image signal processor. The computer vision (CV) processor is configured to match a feature of the input image frame to a corresponding feature of the previous image frame. Determining the image sensor motion data includes determining at least one motion vector relating the input image frame to the previous image frame based on output from the CV processor.

In a twenty-seventh aspect, in combination with the twenty-fifth aspect, the apparatus is configured to determine the corrected image frame includes compensating the at least one motion vector based, at least in part, on the non-image sensor motion data to generate at least one compensated motion vector, the corrected image frame being based on the at least one compensated motion vector.

In a twenty-eighth aspect, in combination with one or more of the twenty-fifth aspect through the twenty-seventh aspect, the image signal processor is further configured to perform operations including determining a distortion correction transform based, at least in part, on the non-image sensor motion data.

In a twenty-ninth aspect, in combination with the twenty-eighth aspect, the apparatus is configured to determine the at least one motion vector is based, at least in part, on the input image frame and the distortion correction transform.

In a thirtieth aspect, in combination with one or more of the twenty-fifth aspect through the twenty-ninth aspect, receiving non-image sensor motion data includes receiving at least one of gyroscope data, accelerometer data, magnetometer data, focus lens position, or optical image stabilization (OIS) lens position. Compensating the at least one motion vector is based, at least in part, on the gyroscope data.

In a thirty-first aspect, in combination with the thirtieth aspect, compensating the at least one motion vector includes compensating the at least one motion vector based, at least in part, on gyroscope data to generate at least one rotation-compensated motion vector.

In a thirty-second aspect, in combination with one or more of the thirtieth aspect through the thirty-first aspect, the at least one compensated motion vector represents translation movement and model and measurements errors. Determining the corrected image frame includes generating a model based, at least in part, on the at least one compensated motion vector. The model represents the translation movement and model and measurement errors. Determining the corrected image frame is based on the camera motion model.

In a thirty-third aspect, in combination with the thirty-second aspect, the image signal processor is further configured to perform operations including determining a distortion correction transform based, at least in part, on a plurality of lens positions corresponding to a plurality of portions of the input image frame.

In a thirty-fourth aspect, in combination with the thirty-third aspect, determining the corrected image frame is based, at least in part, on the distortion correction transform.

In a thirty-fifth aspect, in combination with one or more of the thirty-third aspect through the thirty-fourth aspect, determining the corrected image frame based on the plurality of lens positions corrects intra-frame field of view changes due to the plurality of lens positions.

In a thirty-sixth aspect, in combination with one or more of the thirty-second aspect through the thirty-fifth aspect, the apparatus is configured to include an auto-focus (AF) system coupled to the first lens. The image signal processor is configured to receive the plurality of lens positions from the AF system.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIG. 1, FIG. 4, and FIG. 5 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving an input image frame;
determining non-image sensor motion data corresponding to the input image frame;
determining image sensor motion data corresponding to the input image frame; and
determining a corrected image frame based, at least in part, on the input image frame, the non-image sensor motion data, and the image sensor motion data.

2. The method of claim 1, further comprising receiving a previous image frame, wherein determining the image sensor motion data is also based, at least in part, on the previous image frame.

3. The method of claim 2, wherein:
determining the image sensor motion data comprises determining at least one motion vector relating the input image frame to the previous image frame, and
determining the corrected image frame comprises compensating the at least one motion vector based, at least in part, on the non-image sensor motion data to generate at least one compensated motion vector, the corrected image frame being based on the at least one compensated motion vector.

4. The method of claim 3, further comprising:
determining a distortion correction transform based, at least in part, on the non-image sensor motion data,
wherein determining the at least one motion vector is based, at least in part, on the input image frame and the distortion correction transform.

5. The method of claim 3, wherein receiving non-image sensor motion data comprises receiving at least one of gyroscope data, accelerometer data, magnetometer data, focus lens position, or optical image stabilization (OIS) lens position, and wherein compensating the at least one motion vector is based, at least in part, on the at least one of gyroscope data, accelerometer data, magnetometer data, focus lens position, or optical image stabilization (OIS) lens position.

6. The method of claim 5, wherein compensating the at least one motion vector comprises compensating the at least one motion vector based, at least in part, on the at least one of gyroscope data, accelerometer data, magnetometer data, focus lens position, or optical image stabilization (OIS) lens position to generate at least one rotation-compensated motion vector.

7. The method of claim 3, wherein the at least one compensated motion vector represents translation movement and model and measurements errors, wherein determining the corrected image frame comprises generating a model based, at least in part, on the at least one compensated motion vector, wherein the model represents the translation movement and model and measurement errors, and wherein determining the corrected image frame is based on the translation-based model.

8. The method of claim 7, further comprising rejecting outlying motion vectors of the at least one compensated motion vector before determining the corrected image frame, wherein the corrected image frame is based on the at least one compensated motion vector remaining after rejecting outlying motion vectors.

9. The method of claim 1, further comprising:
determining a distortion correction transform based, at least in part, on a plurality of lens positions corresponding to a plurality of portions of the input image frame,
wherein determining the corrected image frame is based, at least in part, on the distortion correction transform.

10. The method of claim 9, wherein determining the corrected image frame based on the plurality of lens positions corrects intra-frame field of view changes due to the plurality of lens positions.

11. A device, comprising:
a processor; and
a memory coupled to the processor and storing instruction that, when executed by the processor, cause the device to perform operations comprising:
receiving an input image frame;
determining non-image sensor motion data corresponding to the input image frame;
determining image sensor motion data corresponding to the input image frame; and
determining a corrected image frame based, at least in part, on the input image frame, the non-image sensor motion data, and the image sensor motion data.

12. The device of claim 11, wherein the instructions cause the device to perform operations further comprising receiving a previous image frame, wherein determining the image sensor motion data is also based, at least in part, on the previous image frame.

13. The device of claim 12, wherein:
determining the image sensor motion data comprises determining at least one motion vector relating the input image frame to the previous image frame, and
determining the corrected image frame comprises compensating the at least one motion vector based, at least in part, on the non-image sensor motion data to generate at least one compensated motion vector, the corrected image frame being based on the at least one compensated motion vector.

14. The device of claim 13, wherein the instructions cause the device to perform operations further comprising:
determining a distortion correction transform based, at least in part, on the non-image sensor motion data,
wherein determining the at least one motion vector is based, at least in part, on the input image frame and the distortion correction transform.

15. The device of claim 13, wherein receiving non-image sensor motion data comprises receiving at least one of gyroscope data, accelerometer data, magnetometer data, focus lens position, or optical image stabilization (OIS) lens position, and wherein compensating the at least one motion vector is based, at least in part, on the at least one of gyroscope data, accelerometer data, magnetometer data, focus lens position, or optical image stabilization (OIS) lens position.

16. The device of claim 15, wherein compensating the at least one motion vector comprises compensating the at least one motion vector based, at least in part, on the at least one of gyroscope data, accelerometer data, magnetometer data, focus lens position, or optical image stabilization (OIS) lens position to generate at least one rotation-compensated motion vector.

17. The device of claim 13, wherein the at least one compensated motion vector represents translation movement and model and measurements errors, wherein determining the corrected image frame comprises generating a model based, at least in part, on the at least one compensated motion vector, wherein the model represents the translation movement and model and measurement errors, and wherein determining the corrected image frame is based on the camera motion model.

18. The device of claim 17, wherein the instructions cause the device to perform operations further comprising rejecting outlying motion vectors of the at least one compensated motion vector before determining the corrected image frame, wherein the corrected image frame is based on the at least one compensated motion vector remaining after rejecting outlying motion vectors.

19. The device of claim 11, wherein the instructions cause the device to perform operations further comprising:
determining a distortion correction transform based, at least in part, on a plurality of lens positions corresponding to a plurality of portions of the input image frame,
wherein determining the corrected image frame is based, at least in part, on the distortion correction transform.

20. The device of claim 19, wherein determining the corrected image frame based on the plurality of lens positions corrects intra-frame field of view changes due to the plurality of lens positions.

21. A non-transitory computer-readable medium storing instructions that, when executed by a processor of a device, cause the device to perform operations comprising:
receiving an input image frame;
determining non-image sensor motion data corresponding to the input image frame;
determining image sensor motion data corresponding to the input image frame; and
determining a corrected image frame based, at least in part, on the input image frame, the non-image sensor motion data, and the image sensor motion data.

22. The non-transitory computer-readable medium of claim 21, wherein the instructions further comprise instructions that, when executed by the processor of the device, cause the device to perform operations, comprising:
receiving a previous image frame, wherein determining the image sensor motion data is also based, at least in part, on the previous image frame.

23. The non-transitory computer-readable medium of claim 22, wherein the instructions further comprise instructions that, when executed by the processor of the device, cause the device to perform operations, wherein:
determining the image sensor motion data comprises determining at least one motion vector relating the input image frame to the previous image frame, and
determining the corrected image frame comprises compensating the at least one motion vector based, at least in part, on the non-image sensor motion data to generate at least one compensated motion vector, the corrected image frame being based on the at least one compensated motion vector.

24. The non-transitory computer-readable medium of claim 23, wherein the instructions further comprise instructions that, when executed by the processor of the device, cause the device to perform operations comprising:
determining a distortion correction transform based, at least in part, on the non-image sensor motion data,
wherein determining the at least one motion vector is based, at least in part, on the input image frame and the distortion correction transform.

25. The non-transitory computer-readable medium of claim 23, wherein receiving non-image sensor motion data comprises receiving at least one of gyroscope data, accelerometer data, magnetometer data, focus lens position, or optical image stabilization (OIS) lens position, and wherein compensating the at least one motion vector is based, at least in part, on the at least one of gyroscope data, accelerometer data, magnetometer data, focus lens position, or optical image stabilization (OIS) lens position.

26. The non-transitory computer-readable medium of claim 25, wherein compensating the at least one motion vector comprises compensating the at least one motion vector based, at least in part, on at least one of gyroscope data, accelerometer data, magnetometer data, focus lens position, or optical image stabilization (OIS) lens position to generate at least one rotation-compensated motion vector.

27. The non-transitory computer-readable medium of claim 23, wherein the at least one compensated motion vector represents translation movement and model and measurements errors, wherein determining the corrected image frame comprises generating a model based, at least in part, on the at least one compensated motion vector, wherein the model represents the translation movement and model and measurement errors, and wherein determining the corrected image frame is based on the camera motion model.

28. The non-transitory computer-readable medium of claim 27, wherein the instructions further comprise instructions that, when executed by the processor of the device, cause the device to perform operations comprising: rejecting outlying motion vectors of the at least one compensated motion vector before determining the corrected image frame, wherein the corrected image frame is based on the at least one compensated motion vector remaining after rejecting outlying motion vectors.

29. The non-transitory computer-readable medium of claim 21, wherein the instructions further comprise instructions that, when executed by the processor of the device, cause the device to perform operations comprising:
determining a distortion correction transform based, at least in part, on a plurality of lens positions corresponding to a plurality of portions of the input image frame,
wherein determining the corrected image frame is based, at least in part, on the distortion correction transform.

30. The non-transitory computer-readable medium of claim 29, wherein determining the corrected image frame based on the plurality of lens positions corrects intra-frame field of view changes due to the plurality of lens positions.

31. A device, comprising:
a first image sensor;
a first lens coupled to the first image sensor;
an image signal processor coupled to the first image sensor and configured to perform operations comprising:
receiving an input image frame from the first image sensor;
determining non-image sensor motion data corresponding to the input image frame;
determining image sensor motion data corresponding to the input image frame; and
determining a corrected image frame based, at least in part, on the input image frame, the non-image sensor motion data, and the image sensor motion data.

32. The device of claim 31, wherein the image signal processor is further configured to perform operations comprising receiving a previous image frame, wherein the determining the image sensor motion data is also based, at least in part, on the previous image frame.

33. The device of claim 32, further comprising a computer vision (CV) processor coupled to the image signal processor, wherein the computer vision (CV) processor is configured to match a feature of the input image frame to a corresponding feature of the previous image frame, and wherein:
determining the image sensor motion data comprises determining at least one motion vector relating the input image frame to the previous image frame based on output from the CV processor, and
determining the corrected image frame comprises compensating the at least one motion vector based, at least in part, on the non-image sensor motion data to generate at least one compensated motion vector, the corrected image frame being based on the at least one compensated motion vector.

34. The device of claim 33, wherein the image signal processor is further configured to perform operations comprising:
determining a distortion correction transform based, at least in part, on the non-image sensor motion data,
wherein determining the at least one motion vector is based, at least in part, on the input image frame and the distortion correction transform.

35. The device of claim 33, wherein receiving non-image sensor motion data comprises receiving at least one of gyroscope data, accelerometer data, magnetometer data, focus lens position, or optical image stabilization (OIS) lens position, and wherein compensating the at least one motion vector is based, at least in part, on the at least one of gyroscope data, accelerometer data, magnetometer data, focus lens position, or optical image stabilization (OIS) lens position.

36. The device of claim 35, wherein compensating the at least one motion vector comprises compensating the at least one motion vector based, at least in part, on at least one of gyroscope data, accelerometer data, magnetometer data, focus lens position, or optical image stabilization (OIS) lens position to generate at least one rotation-compensated motion vector.

37. The device of claim 33, wherein the at least one compensated motion vector represents translation movement and model and measurements errors, wherein determining the corrected image frame comprises generating a model based, at least in part, on the at least one compensated motion vector, wherein the model represents the translation movement and model and measurement errors, and wherein determining the corrected image frame is based on the camera motion model.

38. The device of claim 37, wherein the image signal processor is further configured to perform operations comprising:
determining a distortion correction transform based, at least in part, on a plurality of lens positions corresponding to a plurality of portions of the input image frame,
wherein determining the corrected image frame is based, at least in part, on the distortion correction transform.

39. The device of claim 38, wherein determining the corrected image frame based on the plurality of lens positions corrects intra-frame field of view changes due to the plurality of lens positions.

40. The device of claim 38, further comprising an auto-focus (AF) system coupled to the first lens, wherein the image signal processor is configured to receive the plurality of lens positions from the AF system.
